(19) United States
(12) Patent Application Publication
(10) Pub. No.: US 2026/0215412 A1
(43) Pub. Date: Jul. 30, 2026

(54) AGROCHEMICAL FORMULATION

(71) Applicant: SYNGENTA CROP PROTECTION AG, Basel (CH)

(72) Inventors: Jennifer CHEESBROUGH, Bracknell, Berkshire (GB); Edouard MARIOTTE, Seraing (BE); Clifford Charles DONALDSON, Bracknell, Berkshire (GB); Isabella DORSMAN, Swindon, Wiltshire (GB)

(73) Assignee: SYNGENTA CROP PROTECTION AG, Basel (CH)

(21) Appl. No.: 19/147,593

(22) PCT Filed: Jan. 4, 2024
(86) PCT No.: PCT/EP2024/050178

§ 371 Date: Jul. 11, 2025

(30) Foreign Application Priority Data
Jan. 13, 2023 (GB) 2300567.1

(51) Int. Cl. A01N 25/02; A01N 25/04; A01N 25/30; A01N 43/56; A01N 43/653; A01P 3/00

(52) U.S. Cl. CPC A01N 25/02; A01N 25/04; A01N 25/30; A01N 43/56; A01N 43/653; A01P 3/00

(57) ABSTRACT

The present invention relates to an emulsion concentrate (EC) formulation of a succinate dehydrogenase inhibitor fungicide, to the manufacture of such a formulation, and to its use in dilute form, for the control of fungal pathogens, in particular in crops of useful plants. More specifically, the invention relates to emulsion concentrates of -difluoromethyl-1-methyl-1H-pyrazole-4-carboxylic acid methoxy-[1-methyl-2-(2,4,6-trichlorophenyl)-ethyl]-amide, comprising a blend of at least 3 surfactants, and an aromatic ester solvent.

The present invention relates to an emulsifiable concentrate (EC) formulation of a succinate dehydrogenase inhibitor fungicide, to the manufacture of such a formulation, and to its use in dilute form for the control of fungal pathogens, in particular in crops of useful plants. More specifically, the invention relates to emulsion concentrates of 3-difluoromethyl-1-methyl-1H-pyrazole-4-carboxylic acid methoxy-[1-methyl-2-(2,4,6-trichlorophenyl)-ethyl]-amide (pydiflumetofen), comprising a blend of at least 3 surfactants.

Two common types of formulation employed in the agrochemical industry are the suspension concentrate (SC) and the emulsifiable concentrate (EC). Both have their advantages and disadvantages. One key advantage with an EC formulation relates to the ultimate delivery of the active ingredient to its target. In a suspension (i.e. a diluted SC) solid agrochemical particles delivered to surface of the are leaf/fungus/insect/nematode, whereas in an emulsion derived from an EC, the agrochemical active ingredient is dissolved in a solvent that allows penetration into the target tissue, e.g. plant tissue, fungi, insect, nematode etc. This more targeted application of the active ingredient can result in greater bio-efficacy and hence permit lower concentrations of active ingredient to be employed in the field. This is beneficial for a number of reasons and is also particularly useful if the active ingredient has poor solubility in commonly used solvents.

Emulsions are colloidal mixture of two or more mutually immiscible liquids. There are two main types of emulsions: (i) oil-in-water (O/W) where the continuous phase is an aqueous solution and the dispersed phase is a water-immiscible organic liquid, typically an oil, and (ii) water-in-oil (W/O) where the continuous phase is the water immiscible organic liquid, and the dispersed phase is aqueous. More complicated emulsions such as O/W/O (i.e. oil droplets contained within aqueous droplets dispersed in a continuous oil phase) are also possible.

Emulsions are thermodynamically unstable; there is a natural tendency for a liquid/liquid system to separate and reduce its interfacial area and, therefore, its interfacial energy. The free energy of emulsion formation is given by Equation 1 below:

$$Δ {G}^{form} = Δ A {γ}_{12} - T Δ S . \qquad Equation 1$$

where ΔA is the change in interfacial area (where A=A₂−A₁), γ₁₂ is interfacial tension, ΔS is change in entropy and T is temperature of the system.

Since a greater number of small droplets are produced on formation of an emulsion, the interfacial area of the system is increased and therefore the surface energy term, ΔAγ₁₂, in Equation 1 is positive. As producing a large number of droplets is accompanied by an increase in configurational entropy, the entropy term, TΔS, is also positive. In most cases ΔAγ₁₂>TΔS, therefore ΔG^{form} is positive and the formation of an emulsion is a non-spontaneous process. Energy must be given to the system for emulsification to occur, such as energy from mixing (one exception to this are micro-emulsions which can form spontaneously and are generally considered to be thermodynamically stable system).

Even after formation, the system remains thermodynamically unstable and the emulsion will break down overtime by several processes. The following forms of instability are mechanisms by which the distribution of droplet size and the homogeneity of the system can change: creaming and sedimentation; coalescence; flocculation; and Ostwald ripening or disproportionation.

Creaming derives its name from the most commonly known example of a de-emulsification process—the separation of milk into its cream and skimmed milk components. Creaming describes this separation of the dispersed phase and continuous phase due to difference in densities. When external forces such as gravity are greater than the random motion of the emulsion droplets (Brownian motion) a concentration gradient builds up in the system. This can result in emulsion droplets moving to the top (if their density is lower than that of the continuous phase) or to the bottom (if their density is larger than that of the continuous phase).

Coalescence is when two or more droplets merge into one larger droplet. It can result from close approach of droplets due to the van der Waals attractive forces between them. It is caused when the thin liquid film between the droplets is ruptured, most likely due to oscillatory waves in the film.

Flocculation may be generally defined as “the aggregation of droplets to give 3-D clusters without coalescence occurring. Importantly, all droplets maintain their own integrity and remain as totally separate entities.” It results from van der Waals attractions between the droplets, when the electrostatic repulsion between them is sufficiently reduced.

Ostwald ripening is where small droplets decrease in size until they disappear and large droplets grow even larger. The fundamental reason for this is the existence of a pressure difference (Δp) across a curved liquid/liquid interface (radius of curvature r and interfacial tension γ), as given by the formula shown in Equation 2.

$$Δ p = \frac{2 γ}{r} \qquad Equation 2$$

This means that Δp is greater for smaller droplets than for larger ones. The chemical potential of molecules making up the droplets is also greater in smaller droplets. It is this difference in chemical potential that drives the migration of molecules from the smaller droplets, across the aqueous continuous phase, into the larger droplets, thus reducing the total free energy of the system.

Kinetic stability of emulsions can be achieved, most commonly by addition of surfactants or surface active agents). Surfactants are amphiphilic (both oil- and water-loving) molecules made up of a hydrophilic ‘head’ and hydrophobic ‘tail’. Due to their dual nature, surfactants ‘sit’ at interfaces. The free energy of a surfactant molecule located at the interface is lower than that of a molecule in the bulk. Absorption of surfactant molecules at the interface is therefore a spontaneous process and results in a decrease of interfacial tension. It can be shown from Equation 1 that by lowering the interfacial tension, γ₁₂, a greater change in interfacial area, ΔA, and therefore smaller size of emulsion droplets can give the same value for the enthalpy term, ΔAγ₁₂. Therefore, addition of surfactant molecules to the system often results in the formation of smaller, more stable emulsion droplets compared to those in a system without any emulsifiers.

The tail group of the surfactant molecule is usually a single or double, straight or branched hydrocarbon chain. The head group can be charged or neutral. Surfactants can be classified into four groups based on head group type: non-ionic, anionic, cationic or amphoteric. Non-ionic surfactants have neutral head groups such as poly(ethylene oxide). Anionic and cationic surfactants have negatively and positively charged head groups respectively. Common examples of these include ether sulphates and quaternised amines. Amphoteric surfactants, also known as zwitterions, combine both a positive and negative group.

In emulsions, at low concentrations (below the critical micelle concentration), surfactants absorb onto the droplet surface by the hydrophobic part, and the hydrophilic part provides a charge stabilisation in the case of anionic and cationic surfactants, and steric stabilisation in the case of non-ionic surfactants. The anionic and cationic surfactants prevent droplet coalescence by imparting static charge to the droplets which makes them mutually repulsive preventing close approach. Non-ionic surfactants create a physical barrier to droplet coalescence. Close approach of emulsion droplets would result in a loss of configurational entropy of the surfactant chains. Therefore, entropy acts as a repulsive force between the droplets.

Hydrophilic Lipophilic Balance (HLB) is a measure of the proportion of the hydrophilic and lipophilic (hydrophobic) parts of a surfactant molecule. The HLB range 8-18 will normally provide good oil-in-water emulsions. With sufficient energy emulsion droplets of both O/W and W/O type are formed: the type that survives is determined largely by the surfactant used. The critical packing parameter p is given by equation 3:

$$p = \frac{v}{{a}_{0} \times lc} \qquad Equation 3$$

where vis the surfactant chain volume, l_{c} is the surfactant chain length and a₀ is the optimal head group area. If p<1, then the surfactant molecules have a greater head group area which increases the hydrophilic part of the molecule. This can be characterised by a high HLB value and results in an oil-in-water emulsion. If p>1, then the surfactant molecules have a greater chain volume which increases the hydrophobic part of the molecule. This can be characterised by a low HLB value and results in a water-in-oil emulsion.

Emulsion droplet size is also one physical property which can affect the stability of an emulsion. Smaller droplets generally result in a more stable emulsion. This is because the very small droplet size causes a large reduction in the gravitational force and Brownian motion may thus be sufficient for overcoming gravity. This can be illustrated by the Stokes' equation (Equation 4) which estimates the creaming or settling rate of the system.

$$v = \frac{2 {r}^{2} ( ρ - {ρ}_{o} ) g}{9 η} \qquad Equation 4$$

where v is the creaming (settling) rate, r is the droplet radius, ρ is the density of the droplet, ρₒ is the density of the dispersion medium, η is the viscosity of the dispersion medium (continuous phase) and g is the local acceleration due to gravity. The equation shows that reducing the droplet radius will reduce the rate of creaming, and is thus a factor to be considered in the production of an agrochemical EC formulation.

Temperature stability of an emulsion, in dilute or concentrated form, is also critical. Since the solubility of any solid is generally dependent on temperature, there is tendency for solids to fall out of solution/crystallise at lower temperature. Crystallization occurs when the concentration of the solute in its solvent exceeds its equilibrium solubility. It thus follows that ideally the agrochemical active ingredient in an EC formulation has a high solubility in the solvent that will be distributed throughout the continuous phase. Thus for an oil in water type emulsion/emulsifiable concentrate it is desirable that agrochemical active ingredient has a high solubility in a water-immiscible solvent, and for a water-in-oil type emulsion/emulsifiable concentrate it is desirable that the agrochemical active ingredient has a high solubility in a water-miscible solvent.

Key requirements for an agrochemical EC formulation relate to (i) the solubility of the agrochemical active ingredient in a water immiscible solvent, which gives rise to good quality emulsion on dilution, (ii) the stability of the emulsion formed on dilution, over a range of temperatures and (iii) the stability of the concentrate during cold storage. It can be seen from the above discussion of the underlying technology that the optimisation of these parameters for any given active ingredient is a non-trivial task and highly dependent upon the specific active ingredient(s) incorporated in the formulation.

The compound 3-difluoromethyl-1-methyl-1H-pyrazole-4-carboxylic acid methoxy-[1-methyl-2-(2,4,6-trichlorophenyl)-ethyl]-amide, the common name for which is pydiflumetofen, is a potent fungicidal agrochemical described in WO2010/063700, which also discusses general formulation options for such N-alkoxy-(phenyl-ethyl)-pyrazole carboxamides. Both WO2015/124542 and WO2015/12543 describe rudimentary formulations of 3-difluoromethyl-1-methyl-1H-pyrazole-4-carboxylic acid methoxy-[1-methyl-2-(2,4,6-trichlorophenyl)-ethyl]-amide, however, the concentration of active ingredient is low and the solvents employed are fully water miscible.

The present invention thus provides an alternative formulation type for 3-difluoromethyl-1-methyl-1H-pyrazole-4-carboxylic acid methoxy-[1-methyl-2-(2,4,6-trichlorophenyl)-ethyl]-amide and addresses the requirements for an optimal emulsifiable concentrate, in particular with respect to the provision of optimal surfactant components for such formulations.

Thus, in a first aspect there is provided a fungicidal emulsifiable concentrate, comprising;
(a) the fungicide 3-difluoromethyl-1-methyl-1H-pyrazole-4-carboxylic acid methoxy-[1-methyl-2-(2,4,6-trichlorophenyl)-ethyl]-amide;
(b) at least one solvent selected from the group consisting of: an aromatic ester solvent, acetophenone, dimethyl lactamide, and gamma butyrolactone; and
(c) a surfactant blend of at least three surfactants, wherein at least two of said surfactants are non-ionic surfactants, and at least one of said surfactants is the anionic surfactant calcium dodecylbenzene sulfonate.

In a further aspect, there is provided a fungicidal emulsion comprising a fungicidal emulsifiable concentrate as described herein and an agrochemically acceptable diluent. Clearly such an emulsion is of the oil-in-water type.

The choice of solvent for an agrochemical EC formulation is important and dependent upon the individual active ingredient that is the solute. In addition, the choice of solvent for an emulsifiable concentrate formulation can have an impact on the physical stability, application properties, and biological performance of the agrochemical formulation. In this case the active ingredient is the fungicide pydiflumetofen or 3-difluoromethyl-1-methyl-1H-pyrazole-4-carboxylic acid methoxy-[1-methyl-2-(2,4,6-trichlorophenyl)-ethyl]-amide to give it its IUPAC name (the name “pydiflumetofen” is used herein interchangeably with the IUPAC name 3-difluoromethyl-1-methyl-1H-pyrazole-4-carboxylic acid methoxy-[1-methyl-2-(2,4,6-trichlorophenyl)-ethyl]-amide). Pydiflumetofen is difficult to solubilize in many commonly employed agrochemical formulation solvents, as mentioned above and demonstrated in Table 1 below.

TABLE 1
Solubility of 3-difluoromethyl-1-methyl-1H-pyrazole-4-carboxylic
acid methoxy-[1-methyl-2-(2,4,6-trichlorophenyl)-ethyl]-amide
in solvents that are suitable for emulsion production. These solvents
were tested for their ability to maintain pydiflumetofen in solution
in the dispersed phase of an aqueous emulsion (aqueous continuous
phase). All solvents are commercially available.

| | | Solubility of |
|---|---|---|
| | Synonyms/further | pydiflumetofen at |
| SOLVENT | information | 25° C. w/w |
| Acetophenone | Methyl phenyl ketone | 17.3 |
| Triethyl phosphate | | 8.82 |
| Gamma butyrolactone | | 14.7 |
| Dimethyl lactamide | | 9.65 |
| Tributyl phosphate | | 6.18 |
| THFA | Tetrahydrofurfuryl | 9.7 |
| | acetate | |
| Trimethylcyclohexanone | 3,3,5 | 10.2 |
| Ethyl lactate | trimethylcyclohexanone | 5.74 |
| Methyl benzoate | | 15.1 |
| Dowanol DPM | Dipropylene glycol | 3.77 |
| Solvesso 200 ND/ULN | methyl ether | 5.85 |
| Octan-1-ol | | 0.63 |

The solvents described above (and others) have been tested for their ability to maintain pydiflumetofen in solution in the dispersed phase of an emulsion formed in a continuous aqueous phase (i.e. for their ability to act as the solvent for the dispersed phase of an oil-in-water type emulsion). Testing was carried out, with pydiflumetofen dissolved at at concentrations of 12.5%, 10.0%, 7.5%, 6.25% and 5% w/v in the EC formulation. From these studies, it was found that both methyl benzoate, and a solvent blend—of di-propylene glycol dibenzoate with dimethyl lactamide—were the better solvents to use in the EC formulations of pydiflumetofen described herein: they are not only able to dissolve higher amounts of 3-difluoromethyl-1-methyl-1H-pyrazole-4-carboxylic acid methoxy-[1-methyl-2-(2,4,6-trichlorophenyl)-ethyl]-amide, but additionally, formulations of pydiflumetofen in these solvents also exhibited good cold storage capability and/or very good emulsion stability upon dilution.

Where a blend of di-propylene glycol dibenzoate and dimethyl lactamide is employed the ratios of di-propylene glycol dibenzoate to dimethyl lactamide of 1:1.36, 1.1:1, 1.3:1 and 3:2 inclusive give the best results. The preferred ratio range is 1.1:1 to 3:2 inclusive di-propylene glycol dibenzoate to dimethyl lactamide.

The present invention is based on the finding that pydiflumetofen is not only difficult to solubilise, but also that emulsions of pydiflumetofen require a blend of different surfactants for optimal emulsification and stability.

As mentioned above emulsions are inherently thermodynamically unstable, and one way of optimising stability is to incorporate surface-active agents or surfactants to act as emulsifiers. Fourteen non-ionic surfactants with different chemistries and a range of HLB values between 6 and 17, were initially screened for their suitability as emulsifiers for EC formulations of pydiflumetofen. None of these gave rise to a stable EC formulation of pydiflumetofen with the desired emulsification properties, when used by themselves as the sole surfactant in the test formulations. However, the five surfactants described in Table 2 gave sufficiently interesting results for them to chosen for further evaluation, with non-ionic surfactants Bⁿⁱ and Cⁿⁱ being the most promising from the solo surfactant screens.

TABLE 2
Non-ionic surfactants tested

| | Surfactant | HLB |
|---|---|---|
| Aⁿⁱ | Castor oil ethoxylate | 12 |
| Bⁿⁱ | POE (11)-synthetic primary C₁₂/C₁₅ alcohol | 12 |
| Cⁿⁱ | Block copolymer of poyhrdroxystearic acid | 6 |
| | and polyalkylene glycol | |
| Dⁿⁱ | Polyoxyethylene sorbitan monolaurate | 17 |
| Eⁿⁱ | Copolymer butanol PO/EO | 17 |

The five non-ionic surfactants listed in Table 2 were then tested in various two-way combinations with the anionic surfactants listed in Table 3.

TABLE 3
Anionic surfactants tested

| | Surfactant |
|---|---|
| A^{an} | Sodium dioctyl sulfosuccinate in petroleum distillate |
| B^{an} | Calcium dodeclybenzene sulfonate (Ca-DDBS) |
| C^{an} | Amine salts of dodecylbenzene sulfonic acid |
| D^{an} | Sodium dioctyl sulfosuccinate in a mixture of propylene |
| | glycol and water |

Surprisingly, whilst Bⁿⁱ and Cⁿⁱ had performed best as solo non-ionic surfactants, when combined with the anionic surfactant B^{an} in two-way blends, non-ionic surfactants Aⁿⁱ, Bⁿⁱ and Dⁿⁱ led to better quality emulsions overall.

However, despite the vast number of two-way surfactant combinations (varying in ratio as well as component) tested, the quality of the emulsions formed were generally poor. Out of the anionic surfactants tested, only calcium dodecylbenzene sulfonate (B^{an} in Table 3, Ca-DDBS) was taken forward for further optimisation.

On the basis of the results obtained with the solo surfactants and with the two-way blends of surfactants described herein, combinations of 3-way emulsifier blends were investigated for their ability to provide good quality emulsions upon dilution in conjunction with acceptable cold storage stability using the tests described herein.

As an example, three-way combinations of two non-ionic surfactants (Dⁿⁱ and Aⁿⁱ Table 2 above) and one anionic surfactant (B^{an}, Table 3 above) at a total level of 10% by weight were tested in 121 different ratios for their ability to emulsify pydiflumetofen dissolved in methyl benzoate to 7.5% w/v. Droplet size and emulsion stability for each ratio were assessed as described in the “materials and methods” below. Table 4 provides the details of the surfactant ratios and results for the five best EC samples analysed (i.e. the lowest AET values and best initial emulsification).

TABLE 4
Best performing 3-way blends of surfactants
following initial assessment of ECs

| | Surfactant composition | | | | |
|---|---|---|---|---|---|
| Sample | (ratio of components) | | | AET | Initial |
| No. | Dni | Ani | Ban | value | emulsification |
| 1 | 4 | 2 | 4 | 0.13 | Very Good |
| 2 | 5 | 1 | 4 | 1.1 | Very Good |
| 3 | 3 | 3.5 | 3.5 | 2.0 | Very Good |
| 4 | 4 | 1 | 5 | 1.17 | Good |
| 5 | 2 | 3 | 5 | 1.67 | Good |

Emulsion stability testing of diluted samples 1 and 2 in hard water samples A and D (Table 5, below), indicated that further improvements could be made in terms of emulsion stability after two hours at both 5° C. and 30° C., and thus two further approaches were taken: (i) to include a further surfactant, and (ii) to vary the total surfactant loading.

In the EC formulations described herein pydiflumetofen can be dissolved in the described solvents at concentrations of 5-10% w/v of total formulation. Preferably EC formulations of the invention will comprise pydiflumetofen at 6-8% w/v of total formulation, and more preferably 6-7% w/v of the total formulation. Specific examples for concentrations of pydiflumetofen in emulsifiable concentrates of the invention thus include 6.0, 6.05, 6.1, 6.15, 6.2, 6.25, 6.3. 6.35, 6.4, 6.45, 6.5, 6.55, 6.6, 6.65, 6.7, 6.75, 6.8, 6.85, 6.9 and 6.95 w/v of the total formulation. The composition will be adjusted for alterations in the amount of active ingredient employed, by varying the total amount of solvent in the composition. Thus the ratio of surfactants remains the same, as does the total content of surfactant. Similarly, even when a solvent blend is employed, the ratio of solvents within that blend remains the same, even if the total solvent content is adjusted.

Additional formulation components may include a silicone-based antifoam up to a maximum concentration of 0.05% w/v, but more typically at concentrations of 0.001%, 0.005%, 0.01%, 0.02%, 0.03%, or 0.04% w/v of total composition.

If desired, in order to prevent microbial contamination of the emulsifiable concentrate during prolonged storage in adverse conditions, a microbiocide/antibiotic component may also be included within the formulation.

Additional fungicidal active ingredients may be incorporated in the emulsifiable concentrates of the invention, alongside 3-difluoromethyl-1-methyl-1H-pyrazole-4-carboxylic acid methoxy-[1-methyl-2-(2,4,6-trichlorophenyl)-ethyl]-amide. Preferred examples of additional fungicidal active ingredients for use in such combinations include the azole fungicides, and in particular an azole selected from the group consisting of difenoconazole, prothioconazole, propiconazole and tebuconazole. Out of these, prothioconazole is the preferred mixing partner.

### Formulation Development Materials and Methods

Described below are methods and equipment that were used in the identification and characterisation of the emulsifiable concentrates of the invention described herein.

### Droplet Size Analysis:

As discussed above, droplet size has an impact on formulation stability and in general the smaller the droplet size the more stable the formulation. The droplet size in test EC formulations of 3-difluoromethyl-1-methyl-1H-pyrazole-4-carboxylic acid methoxy-[1-methyl-2-(2,4,6-trichlorophenyl)-ethyl]-amide was analysed by a variety of methods including laser diffraction (using a laser diffraction particle size analyser from Malvern Panalytical Ltd), optical microscopy, and through the use of an Agrochemical Emulsion Tester (AET) from Rank Brothers Ltd. The AET provides an emulsion stability reading as a function of turbidity and droplet size. The higher the value, the larger the distribution of droplet size and the lower the emulsion stability; the smaller the value, the more stable the emulsion and a narrower distribution of smaller droplet size.

### Emulsion Stability Testing:

Test sample of EC formulations of 3-difluoromethyl-1-methyl-1H-pyrazole-4-carboxylic acid methoxy-[1-methyl-2-(2,4,6-trichlorophenyl)-ethyl]-amide were diluted in standard water samples of known hardness (Table 5) in crow receivers, which were then incubated overnight at 5° C. and 30° C.

TABLE 5
Properties of standard water samples
for emulsion dilution and testing

| | | | Ratio |
|---|---|---|---|
| Standard water | Hardness/ppm | pH | Ca²⁺:Mg²⁺ |
| A | 20 | 5.0-6.0 | 1:1 |
| B | 20 | 8.0-9.0 | 4:1 |
| C | 500 | 7.0-8.0 | 4:1 |
| D | 342 | 6.0-7.0 | 4:1 |

Initial emulsification was assessed in the morning using the four-point scale described in Table 6 below.

TABLE 6
Assessment criteria for initial emulsification

| Value | Criteria |
|---|---|
| A | Complete emulsification to a cloud without visible |
| | droplet formulation: good bloom and strike. |
| B | Cloud formation with a few isolated droplets: |
| | acceptable bloom and strike |
| C | Cloud formation with numerous droplets or separation |
| | of an oily phase: poor bloom and strike |
| D | Droplet formation or separation of an oily phase |
| | without emulsion formation: no bloom or strike. |

Emulsion quality was assessed visually after homogenising the samples through inversion, using a scale of 0 to 5 as shown in Table 7 below.

TABLE 7
Emulsion quality criteria

| Value | Criteria |
|---|---|
| 0 | Transparent clear emulsion or micro-emulsion |
| 1 | Highly colloidal emulsion. Sample is opalescent, with |
| | blue tinge. |
| 2 | Fine emulsion with high colloidal component. |
| 3 | Moderately fine emulsion without colloidal component, |
| | with barely visible individual drop. |
| 4 | Coarse emulsion, that in a thin layer consists of easily |
| | visible droplets when viewed close up, but appears |
| | like milk when viewed from about 40 cm |
| 5 | Very coarse emulsion, discrete droplets are visible |

Further visual assessments were carried out 0.5, 2 and 24 hours post homogenisation and the volume of any cream or oil recorded. After 24 hours, the samples were re-homogenised and number of inversions required for re-emulsification was recorded and the samples were re-incubated at 5 or 30 (as appropriate) and a final visual assessment, including by microscopy was carried out.

### Foam Persistence Testing—Small and Medium Scale

The small-scale test involves preparation of 200 ml of emulsion at the maximum application rate. First 180 ml of standard water D is weighed into a 250 ml measuring cylinder. Then the required mass of formulation is added and topped up with water to 200 ml. The cylinder is stoppered and inverted 30 times over the course of 60 seconds (approx. 2 secs per inversion). The level of foam is recorded after 10 secs, 1 min, 3 mins and 12 mins.

The mid-scale (10 litre) test employs high levels of mechanical agitation to induce foaming. The test is performed in a clear glass tank and measurements are taken of the height of foam at various time periods throughout the test.

### EC Formulation Storage Stability

Samples of EC formulations were stored under the conditions listed in Table 8 below. The samples were assessed visually for phase separation, crystallisation, change in colour, turbidity and viscosity. Stored samples are also tested for pH and the stability of any resulting emulsion. Chemical stability of the active ingredient was assessed via HPLC analysis for any breakdown products.

TABLE 8
Storage conditions for assessing long-term storage stability

| Storage conditions | Comments |
|---|---|
| Eight weeks at 40° C. | Mimics storage at ambient |
| | temperature for 2 years |
| Two weeks at 54° C. | Shows response to storage |
| | at elevated temperature. |
| | Also mimics storage at ambient |
| | temperature for 2 years. |
| Cold storage at carrying | Shows response to low |
| temperatures | temperature storage |
| (10, 5, 0, −5, −10° C.) | conidations. |
| | Can provide an indication of |
| | temperature at which |
| | crystalisation occurs |
| Cycling temperature between | Reflects diurnal temparture |
| plus 10° C. and minus 10° C.: 12 | variation |
| hours storage at each temperature | |
| Prolonged storage at 25° C. | Samples analysed at 6, 12 |
| | and 24 months |

### Application Testing

Spray tests were carried by spraying through standard spray nozzles fitted with nozzle filters. Test emulsions were made by large scale dilution of emusifiable concentrates in tap water in a 100 L commercial farm sprayer tank. After spraying, the spray tank, filters and nozzles were checked for sediment.

### FORMULATION EXAMPLES

The EC formulations of the invention were developed as described hereinbefore. The following three EC formulations comprising 3-difluoromethyl-1-methyl-1H-pyrazole-4-carboxylic acid methoxy-[1-methyl-2-(2,4,6-trichlorophenyl)-ethyl]-amide at 6-7% w/V, described in Table 9 below are provided as specific examples of the invention. Where a solvent blend is employed the di-propylene glycol dibenzoate to dimethyl lactamide ratio sits in the optimal range 1.1:1 and 3:2 inclusive, at 3:2 for EC3 and at 1.1:1 for EC2. The total amount of emulsifier in the emulsifiable concentrate is 10% w/v for EC1, 15% w/v for EC2, and 15% w/v for EC3.

TABLE 9
Composition of emulsifiable concentrates of 3-difluoromethyl-1-methyl-1H-pyrazole-
4-carboxylic acid methoxy-[1-methyl-2-(2,4,6-trichlorophenyl)-ethyl]-amide

| Function of component | EC1 | EC2 | EC3 |
|---|---|---|---|
| Active ingredient | 3-difluoromethyl-1-methyl- | 3-difluoromethyl-1-methyl- | 3-difluoromethyl-1-methyl- |
| | 1H-pyrazole-4-carboxylic | 1H-pyrazole-4-carboxylic | 1H-pyrazole-4-carboxylic |
| | acid methoxy-[1-methyl-2- | acid methoxy-[1-methyl-2- | acid methoxy-[1-methyl-2- |
| | (2,4,6-trichlorophenyl)- | (2,4,6-trichlorophenyl)- | (2,4,6-trichlorophenyl)- |
| | ethyl]-amide 6.25% w/v | ethyl]-amide 6.25% w/v | ethyl]-amide 6.25% w/v |
| Active ingredient | — | — | Prothioconazole 7.5% w/v |
| Solvent for active | Methyl benzoate | Dipropylene glycol | Dipropylene glycol |
| ingredient(s) | | dibenzoate | dibenzoate |
| Solvent for active | — | Dimethyl lactamide | Dimethyl lactamide |
| ingredient(s) | | | |
| Surfactant | condensation product of | condensation product of | condensation product of |
| | castor oil and ethylene | castor oil and ethylene | castor oil and ethylene |
| | oxide | oxide | oxide |
| Surfactant | calcium dodecylbenzene | calcium dodecylbenzene | calcium dodecylbenzene |
| | sulfonate; | sulfonate; | sulfonate; |
| Surfactant | copolymer butanol | copolymer butanol | copolymer butanol |
| | PO/EO; | PO/EO; | PO/EO; |
| Surfactant | polyoxyethylene sorbitan | — | — |
| | monolaurate | | |
| Antifoam | Silicone antifoam | Silicone antifoam | Silicone antifoam |
| | emulsion | emulsion | emulsion |

Each of these emulsifiable concentrates, EC1, EC2, and EC3 exhibited excellent stability in concentrate form, as well as the ability to produce good stable emulsions upon dilution.

EC1 and EC2 are directly comparable, in that they contain 3-difluoromethyl-1-methyl-1H-pyrazole-4-carboxylic acid methoxy-[1-methyl-2-(2,4,6-trichlorophenyl)-ethyl]-amide as the sole active ingredient. Using the tests described above under Formulation Development, it could be seen that 3-difluoromethyl-1-methyl-1H-pyrazole-4-carboxylic acid methoxy-[1-methyl-2-(2,4,6-trichlorophenyl)-ethyl]-amide had greater solubility in EC1 and the formulation exhibited better cold storage properties than EC2. However, the emulsion formed upon dilution of EC2 exhibited greater stability than the emulsion formed upon dilution of EC1.

EC3 shows that a further active ingredient, in this case the azole fungicide prothioconazole can also be incorporated in the EC formulations of the invention.

1. A fungicidal emulsifiable concentrate, comprising;
(a) the fungicide 3-difluoromethyl-1-methyl-1H-pyrazole-4-carboxylic acid methoxy-[1-methyl-2-(2,4,6-trichlorophenyl)-ethyl]-amide;
(b) at least one solvent selected from the group consisting of: an aromatic ester solvent, acetophenone, dimethyl lactamide, and gamma butyrolactone;
(c) a surfactant blend of at least three surfactants, wherein at least two of said surfactants are non-ionic surfactants, and at least one of said surfactants is the anionic surfactant calcium dodecylbenzene sulfonate.

2. The fungicidal emulsifiable concentrate of claim 1 wherein the aromatic ester solvent is selected from dipropylene glycol dibenzoate and methyl benzoate.

3. The fungicidal emulsifiable concentrate of claim 1, wherein one of said non-ionic surfactants is castor oil ethoxylate.

4. The fungicidal emulsifiable concentrate of claim 1, wherein one of said non-ionic surfactants is copolymer butanol PO/EO.

5. The fungicidal emulsifiable concentrate of claim 1, comprising a second solvent, different to the first solvent and selected from the group consisting of: an aromatic ester solvent, acetophenone, dimethyl lactamide, and gamma butyrolactone.

6. The fungicidal emulsifiable concentrate of claim 6, wherein the second solvent is dimethyl lactamide.

7. The fungicidal emulsifiable concentrate according to claim 1, comprising a third non-ionic surfactant.

8. The fungicidal emulsifiable concentrate of claim 7, wherein the third non-ionic surfactant is polyoxyethylene sorbitan monolaurate.

9. The fungicidal emulsifiable concentrate of claim 1, comprising a second fungicide selected from the azole group of fungicides.

10. The fungicidal emulsifiable concentrate of claim 9, wherein the second fungicide is selected from the group consisting of difenoconazole, propiconazole, prothioconazole, and tebucanazole.

11. The fungicidal emulsifiable concentrate of claim 1, comprising:
(a) the fungicide 3-difluoromethyl-1-methyl-1H-pyrazole-4-carboxylic acid methoxy-[1-methyl-2-(2,4,6-trichlorophenyl)-ethyl]-amide;
(b)(i) methyl benzoate;
(c)(i) a condensation product of castor oil and ethylene oxide;
(c)(ii) calcium dodecylbenzene sulfonate;
(c)(iii) copolymer butanol PO/EO;
(c)(iv) polyoxyethylene sorbitan monolaurate; and
(d) silicone antifoam.

12. The fungicidal emulsifiable concentrate of claim 11, wherein the weight ratio of c(i):c(ii):c(iii) is 2:2:1.

13. The fungicidal emulsifiable concentrate of claim 11, wherein the weight ratio of c(i):c(ii):c(iii):c (iv) is 3:3:1:3.

14. The fungicidal emulsfiable concentrate of claim 1, comprising:
(a) the fungicide 3-difluoromethyl-1-methyl-1H-pyrazole-4-carboxylic acid methoxy-[1-methyl-2-(2,4,6-trichlorophenyl)-ethyl]-amide;
(b)(i) dipropylene glycol dibenzoate;
(b)(ii) dimethyl lactamide;
(c)(i) a condensation product of castor oil and ethylene oxide;
(c)(ii) calcium dodecylbenzene sulfonate;
(c)(iii) copolymer butanol PO/EO; and
(d) silicone antifoam.

15. The fungicidal emulsifiable concentrate of claim 9, comprising:
(a)(i) the fungicide 3-difluoromethyl-1-methyl-1H-pyrazole-4-carboxylic acid methoxy-[1-methyl-2-(2,4,6-trichlorophenyl)-ethyl]-amide;
(a)(ii) prothioconazole;
(b)(i) dipropylene glycol dibenzoate;
(b)(ii) dimethyl lactamide;
(c)(i) a condensation product of castor oil and ethylene oxide;
(c)(ii) calcium dodecylbenzene sulfonate;
(c)(iii) copolymer butanol PO/EO; and
(d) silicone antifoam.

16. The fungicidal emulsifiable concentrate of claim 14, wherein the weight ratio of c(i):c(ii):c(iii) is 2:2:1.

17. The fungicidal emulsifiable concentrate of claim 14, wherein the weight ratio of (b)(i):(b)(ii) is between 1.1:1 and 3:2 inclusive.

18. A fungicidal emulsion, comprising a fungicidal emulsifiable concentrate according to claim 1 that has been diluted with an agrochemically acceptable aqueous diluent.

19. Use of a fungicidal emulsifiable concentrate according to claim 1, or of a fungicidal emulsion thereof, for the control of fungal pathogens in crops of useful plants.

20. A method of producing a fungicidal emulsion concentrate as defined in claim 1, which comprises combining 3-difluoromethyl-1-methyl-1H-pyrazole-4-carboxylic acid methoxy-[1-methyl-2-(2,4,6-trichlorophenyl)-ethyl]-amide; at least one solvent selected from the group consisting of dipropylene glycol dibenzoate, methyl benzoate acetophenone, dimethyl lactamide, and gamma butyrolactone, the anionic surfactant calcium dodecylbenzene sulfonate and at least two non-ionic surfactants.
